(19) United States
(12) Patent Application Publication
(10) Pub. No.: US 2026/0001224 A1
(43) Pub. Date: Jan. 1, 2026

(54) Determination of Task Plans for Robotic Devices

(71) Applicant: Sarcos Corp., Salt Lake City, UT (US)

(72) Inventors: Denis Garagic, Salt Lake City, UT (US); Fraser M. Smith, Salt Lake City, UT (US); Marc X. Olivier, Salt Lake City, UT (US)

(21) Appl. No.: 19/256,118

(22) Filed: Jun. 30, 2025

Related U.S. Application Data
(60) Provisional application No. 63/666,097, filed on Jun. 28, 2024.

(51) Int. Cl. B25J 9/16

(52) U.S. Cl. CPC B25J 9/1661; B25J 9/163

(57) ABSTRACT

Technology is described for determining a task plan that is usable by a robotic device in a workspace. The method can include converting instructions received for the robotic device into temporal logic (TL) statements and to a non-deterministic Buchi Automaton. A task probabilistic machine learning model can be generated with feasible task plans using the non-deterministic Buchi Automaton. A plurality of task plans can also be created or generated using the task probabilistic machine learning model. A sensor probabilistic machine learning model of the workspace can be constructed using information from sensors of the robotic device. The task plans from the task probabilistic machine learning model can be compared with the sensor probabilistic machine learning model to select the task plan with a high probability of correlation to the workspace.

### PRIORITY CLAIM

The patent application claims priority to U.S. provisional patent application Ser. No. 63/666,097, entitled “Determination of Task Plans for Robotic Devices” filed Jun. 28, 2024.

### GOVERNMENT LICENSE RIGHTS

This invention was made with Government support under FA8649-20-C-0175 awarded by USAF Research Lab AFRL SBRK; and FA8750-22-C-1005 awarded by Air Force Research Laboratory. The Government has certain rights in the invention.

### BACKGROUND

Robotic systems, such as manufacturing robots, robotic vehicles and humanoid robots are becoming more robust, powerful and capable. Manufacturing robots, robotic vehicles and humanoid robots are also becoming more prevalent in practical uses as the technologies and efficiencies improve. Some industrial applications employ robots that are fixed in place or have limited mobility to manufacture products or perform industrial work.

Automated manufacturing using robots is desirable in many manufacturing situations. Installing a robot in a manufacturing plant usually provides productivity gains and the owner of the robot may be happy with the robot for a time. However, at some point the owner of the robot may need to change what tasks the robot performs because the manufactured product or manufacturing process needs to change. In order to change what the robot does, the robot must be halted and an external third party or a separate internal engineering group may be brought in to setup the new robot functions or schema. The economic costs of re-programming robots in manufacturing or other situations is a significant economic cost each time a robot's tasks change. Using specialized resources each time a robot needs to be reconfigured is inconvenient and can be relatively expensive.

### BRIEF DESCRIPTION OF THE DRAWINGS

FIG. 1 is a block diagram illustrating an example high level overview of a method for determining a task plan that may be usable by a robotic device in a workspace.

FIG. 2 is a block diagram illustrating an example of a query (e.g., language instructions) translation process that creates query graphs and probabilistic machine learning models.

FIG. 3 is a diagram illustrating an example of how an inference can be conditioned on a task probabilistic machine learning model (i.e., query model) that interacts with a sensor probabilistic machine learning model.

FIG. 4 is a diagram illustrating an example of an inference that can be based on a query (language instruction) model.

FIG. 5A is a block diagram that illustrates an example of a task plan generation architecture using machine learning behavior and performance guarantees while continuously learning and adapting to changes in a physical environment.

FIG. 5B is a chart illustrating an example of a task plan generation capability that learns compact models or primitives to generate operations or behavior patterns with limited training data.

FIG. 6 illustrates an example of a cognitive compositional learning architecture with a single unified learning approach to address challenges.

FIG. 7 illustrates an example of a general closed-loop autonomy architecture to deliver value added software services.

FIGS. 8 and 9 illustrate examples of online sensor control for robot situational awareness.

FIGS. 10 and 11 illustrate examples of robots that learn by demonstration and can then generalize tasks in new environments.

### DETAILED DESCRIPTION OF THE PREFERRED EMBODIMENTS

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology may provide a closed-loop motion planning and contextual reasoning system that is capable of executing tasks received from users, where the tasks may have been modified or refined through using demonstrations of successful tasks recorded by humans. Closed-loop motion planning refers to the dynamic and adaptive process of planning and executing movements in real-time, while reacting to the environment and changing conditions as needed. This approach is particularly valuable when performing tasks that have been learned through demonstrations provided by humans or where the robot has recorded the actions provided by a human.

These capabilities can be applied across various industries, including manufacturing, logistics, healthcare, transportation and more. Robust motion planning, modification and execution allows robots to autonomously perform tasks with a high degree of precision and adaptability, even in unpredictable or changing environments.

For example, in manufacturing, a robot equipped with closed-loop motion planning can efficiently assemble complex products, all while adjusting its movements based on real-time feedback from the assembly line and avoiding objects that are obstacles. In a healthcare setting, a robot can assist in delicate surgical procedures, responding to the surgeon's commands and adapting to the patient's anatomy. These improvements can enhance the efficiency and versatility of robotic systems, ultimately contributing to increased productivity and improved safety across numerous domains.

This disclosure describes a system for achieving closed-loop autonomy in unstructured environments. The system may include at least three components: Learning, Reasoning, and Action. Learning encompasses the efficient acquisition of knowledge, achieved through techniques such as one-shot learning or few-shot learning methods. This efficiency significantly reduces the need for extensive specialized training or programming. Reasoning may enable contextual adaptation and the ability to respond sensibly to unforeseen situations. Reasoning may also empower the system to learn from new experiences, without requiring voluminous specialized training.

The Action component may involve the application of previously acquired knowledge to novel situations. This adaptive capacity can enable the system to dynamically formulate optimal plans and courses of action. The adaptivity may be achieved without increasing the system's self-complexity, effectively enhancing operational speed and scale. The system's perceptual capabilities are designed to process rich, complex, and subtle information from the system's environment. The robot and/or system may continuously learn within the surroundings and can abstract information to derive new meanings. This abstraction process enhances its reasoning abilities, which it employs for planning and decision-making.

This AI-based software framework is hardware-agnostic, meaning it can be applied to enable autonomy for both fixed-based and floating-based robotics. The system can be deployed to enable autonomous operations for a range of robotics systems, including fixed-based robotics such as serial robotic arms, and floating-based robotics such as humanoids, exoskeletons, bipedal robots, quadrupeds, UAVs, and more. These robotic systems are capable of performing dexterous locomotion and manipulation tasks in unstructured environments characterized by constantly changing workspaces and scenes. These unstructured environments may include construction, warehouse logistics, situational awareness and surveillance, industrial inspection, and industrial automation.

In one example, a method may be provided for receiving speech or text language instructions from a user regarding a task which a robot is desired to perform. This may be a description of an execution of a complex manipulation task. This instruction can be translated and/or mapped to a probabilistic machine learning (ML) model that is task oriented for a robot (e.g., aerial, ground, or manipulator robotic platform) to enable motion tasks to be performed.

Quantitative mathematical machine learning models can help supervised autonomous systems better understand their environment and plan and execute complex tasks, by interpreting instructions based on how a human worker would perform specified industrial tasks using a query or instructions from a user and scene analysis.

As input, a user (e.g., an assembly line worker) may describe a sequence of actions through text entries, speech or graphics detailing how to manipulate objects to perform long-horizon tasks for a robot. A domain-specific language model can be used to capture these instructions and autonomously translate them into Temporal Logic statements consisting of states, actions, and predicates.

The long-horizon task plan, expressed in Temporal Logic (TL) formalism to encode the worker's task description may then be converted into a non-deterministic Buchi Automaton. This automaton consists of states and a transition function, determining the automaton's movement between states based on input characters. Some states are accepting, with one designated as the start state. The Buchi Automaton's transition function can have multiple outputs, leading to various paths for the same input. The Buchi Automaton accepts infinite input only if at least one path is received. The Buchi automaton is may be a foundation for a probabilistic machine learning model, which generates all feasible task plans. The Buchi Automaton can be displayed as a graph, if desired.

In this technology, Temporal Logic is created from (i.e., interprets) user instructions (i.e., queries). After constructing a system of probabilistic machine learning models, the process can further analyze scene observations on those relevant to a given query.

Accordingly, a Temporal Logic (TL) formalism can encode the worker's task description or query. This formalism has two advantages over first-order logic (FOL) formalism. First, it provides a natural and compact way of encoding temporal and rational conditional constraints. Second, not only are there several kinds of Temporal Logic available for use (Linear Temporal Logic (LTL), Computational Tree Logic (CTL), Bounded LTL, etc.), but there also exist known processes that can convert TL formulas into probabilistic machine learning models. Furthermore, TL expressions can be converted into a graphical query representation for display when desired.

Since the task operates within a specific workspace and involves manipulating various objects, perception is essential to observe the scene. Sensors of the robot may perceive the scene using sensors that can sense visible light, infrared light, laser light (e.g., light detection and ranging (LIDAR)), sound, temperature or other types of sensing mechanisms. One set of probabilistic machine learning models may be used to detect, classify, and estimate the poses of all objects in the workspace. A pose represents the position and orientation and when an object is in the right orientation or pose then the object may be picked up the robot.

In this technology, the two probabilistic machine learning models—one generated by the user, capturing all possible feasible task execution ways, and the other inferred from sensor perception can then be compared. Through a model-checking process, the task plan that matches the scene description can be selected. This plan may then executed, and its model is saved.

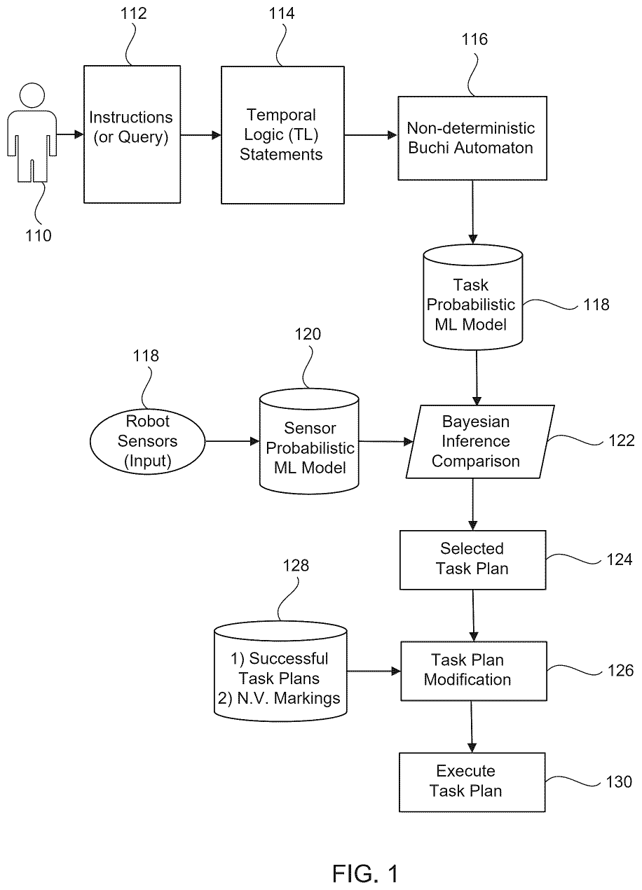

FIG. 1 is a block diagram illustrating an example high level overview of a method for determining a task plan that is usable by a robotic device in a workspace. Initially, instructions 112 (e.g., a command) may be received from a user 110 of the robotic device or system. The user may be a human expert that provides these instructions describing the way a human would perform the tasks. The instructions may be a sequence of actions in a domain-specific language that is known in advance to users. The domain-specific language may have a restricted command set where the instruction words, tokens or keywords are known in advance. For example, the robot may receive instructions to go left, right, pickup an object, define object name, move part Z to the yellow bin, etc. The instructions may be received using at least one of: a verbal query, a text query, a graphical query or another type of query that can be received by the computing systems of the robotic device. For example, the instructions may be pre-recorded audio, text, video, graphics, icons, motions, controller movements, or scripts.

The instructions 112 received for the robotic device can be converted into temporal logic (TL) statements 114 and to a non-deterministic Buchi Automaton 116. The temporal logic (TL) statements may include states, actions, and predicates. In addition, the non-deterministic Buchi Automaton may include states and a transition function to modify states based on actions and predicates.

A task probabilistic machine learning model 118 may be generated that has feasible task plans, using the non-deterministic Buchi Automaton 116. A plurality of task plans may then be generated using the task probabilistic machine learning model 118.

A sensor probabilistic machine learning model 120 of the workspace can be constructed using information from sensors of the robotic device 118. This sensor probabilistic machine learning model 120 may be stored in memory or displayed for a user to view. The sensor probabilistic machine learning model may classify objects and estimate poses of objects in the workspace. Further, the sensor probabilistic machine learning model can classify objects that need to be manipulated by the robotic device and objects that need to be avoided by the robotic device during the task completion.

The task plans from task probabilistic machine learning model 118 can be compared with the sensor probabilistic machine learning model 120 to select 124 a task plan with a high probability of correlation to the workspace. Comparing the plurality of task plans from the task probabilistic machine learning model with the sensor probabilistic machine learning model may be performed using Bayesian inference with a defined probability threshold. In other words, the Bayesian inference 122 can be used to compare the command converted into a state diagram to a state diagram representing the environment. The output from the Bayesian may represent the probability (e.g., high/low) that the robot can do a specific operation and/or the task plan with the highest probability of performing the instructions may be selected. An error message may be generated if there is a missing item or this task plan cannot be performed, etc.

A task plan can include multistep task plans (long horizon tasks) or a task plan may be an individual step or group of short steps. The comparison may generate a difference condition that the robot needs to close the loop on by taking action with a task plan.

The task plan may be modified 126 to correct for deficiencies as compared to additional inputs such as stored successful task plans, non-visible markings on objects or workspace data. Examples of the workspace data may be poses of objects or people in the workspace that need to be avoided. In another example, a pose of an object that is not identifiable using a robotic device sensor may be moved in order to allow the object to be recognized. By modifying task plans as compared to various reference data sources described above, the task plan may be adapted to the situation the robot faces before execution occurs. The modifications may occur as the task plans are created or as the robot is executing the task plans. This means the robot does not have to be shut down for the system to make task plans and other modifications. For example, a robot in a work space may identify an object that is to be manipulated. For the robot to approach the object from the robot's current position, the robot may identify a separate object that is in the way. This change in the work space or scene means the robot may change its task plan to avoid the object.

A learning data store 128 may be created with successful task plans that have been completed by a human. The task plan selected can be compared to stored successful task plans to determine whether to modify the task plan or execute the task plan 130. A successful task plan can be defined as successful based in part on completion by a user using the robotic device or a user flagging that the successful task plan should be stored. The user knows they have completed a successful task plan (i.e., move the block from point A to B) and the successful task plans can be recorded.

A data store of successful task plans 128 can be created using what may be called success based learning. A data store of task completions may record task completions performed with the person controlling the robot directly. The user can tele-operate the robot and perform tasks with the robot. This allows the human to control the poses, movements and trajectory of the robot directly. The correctly completed task plans or successful task plans may be stored in the data store. For example, the successful task plans may have recorded how to pick up the object and translate the object in the workspace. In addition, the task plans may or may not store load information (e.g., for lifting or moving objects).

Success based learning in robot environment allows the user or person to repeat an operation repeatedly and record the completion of each successful task. The recording of the multiple operations or many versions of the same task or task type can generate a variance or tolerance for the task or task type. A human who does an operation for a task will typically be within 1% of perfect every time. This indicates that the success based learning data store will have some variation for operations but not a large amount. The greatest variation may be in accommodating robot degrees of freedom (DOF) and the user may have to pick up object in various ways for oddly positioned work pieces and to match a robot's DOF. The user may position objects in various positions to train the robot that the robot can pick-up objects in certain ways. Most robots have five or six degrees of freedom (DOF) and the user can perform operations to be recorded (e.g., some awkward things) to make up for the loss of one to two DOFs in some robots. The reduced DOF for a robot allow a work environment to impose constraints so that less expensive robots can be used.

The success based learning can provide a data store with only successful or good task plans. The good task plans can be identified without spending an inordinate amount of time extracting out successful task plans. Success based learning can also bypass a collection of time intensive and statistically suspect methods of identifying success for tasks. Success based learning allows a person to be involved and so a stored task is known to be successful and 100% good, when stored.

The size of the data store storing the task plans can be increased as time passes to include task plans with changes in configuration or environmental details that did not exist initially. If for example, a new object is located in the environment, then the robot can detect that object and form new task plans for the new object in the environment. This may result in a new branch or collection of recorded operations and task plans in the database. A human may also create new tasks for the detected workspace variations as they are detected. This may ensure that any new task plans are 100% correct. Creating a success based data store is time efficient, and can handle higher complexity task plans than reinforcement learning or similar machine learning models can generate.

In one embodiment, when the robot encounters an unsatisfactory situation or an error condition, then a person can intervene with an appropriate teleoperation interface and perform the task. This successful task can be stored into the success based database. Of course, the task can also be immediately used by the robot to perform the currently desired operations. Gaps in the success based data store may be filled by allowing the success based data store to be added to interactively upon failure of task plans created for the robots.

One result of the present technology is to return control of a robot and the programming of the robot to people who own the robot. An efficient way is provided to enable reprogramming of robot tasks so that changes to the robots work patterns are not a huge economic cost each time the robot's tasks change. The use of robots in the world is widely spread, especially in manufacturing, and having a robot in a manufacturing plant is useful. However, it can be expensive and difficult to change what the robot does. For example, the robot may need to be down or inoperable while changes are being made and it may take an external third party to setup a new robot schema. This technology can provide a human machine interface that is effective, efficient and simple, so the users in a manufacturing plant can change, modify or create the tasks the robot performs without engaging the third party. Ideally, the interface may be so efficient that the robot is only disable for a limited time (e.g., 30 minutes) and then the robot and system are reconfigured and ready to perform tasks again. Further, this technology can provide robots with closed-loop autonomy where the task plans are modified in real time in response to environment changes or other needs without deactivating the robots.

In other types of machine learning systems such as reinforcement learning, twenty robots may be used that have no knowledge about the environment or knowledge of unsuccessful patterns. Then the users training the robot may ask the robot to pick-up an object. Of course, the robot will fail an extremely high percentage of the time. Then there are some successes and the successes train the system over time. Unfortunately, such training can take an extremely long time to generate a successfully completed task plan. In addition, there may be partial successes. In partial successes, the robot may have picked up the object but it was an unrepeatable action (not repeatable because it was caught on the edge of the gripper or the object got caught on something on the arm or fingers for example). Such partially successful cases pollute the data set with partial successes that are not statistically highly successful (e.g., 99% or 100%).

Using typical forms of reinforcement learning with no knowledge base, it can be extremely difficult to create more involved task sets or longer task sets. This is partially because reinforcement learning and similar types of machine learning can take so long to build the simple tasks. A user may want the robot to 1) take an object from A to B; 2) perform an operation at location B and the object must be a specific orientation; and 3) then take the object from B to location C. The longer the desired task plan chain, the more unlikely the task plan is to ever be discovered by randomly trying to complete a task (e.g., picking up an object up over and over again).

In a contrasting example, a user knows to pick-up an object and pick-up the object from a defined side because the user wants to do a defined task. When a user completes a task plan in this way, the data set only includes task plans that are 100% successful. Every task plan in the data set is usable by the robot and can be used for building more complex task plans. It is also possible to have different people do the same task repeatedly or same person doing one task over and over again to generate clusters of task recordings. This generates a second order part of the data set which is the variation around 100% successful tests, and these clusters of tests are also 100% successful. This lets you know how inaccurate the robot can be and still accomplish the task 100% of the time. The success based learning data store or similar data store can record these clusters of 100% successful task plans.

As discussed earlier, a task plan is selected from comparing the task probabilistic machine learning model or state diagram (i.e., state table), and the sensor probabilistic machine learning model or perception based state diagram (that came from cameras and sensors). This task plan can be compared with the success based learning data store. More specifically, the task plan can be compared to similar already recorded task plans. The task plan from the instructions can be translated in such a way that a specific part of the success based learning data store can be searched for similar successful task plans. Similar successful task plans can be used as a template for modifying or correcting a selected task plan for doing operations in the environment.

The success based learning data store is robust because it contains only successfully completed task plans. The success based learning data store also has the variations that have been captured from the human completed task plans. For example, the robot might find objects that need to be moved starting out in all possible configurations and that is variation can be handled in the success based learning data store. Using a robust success based data store that has already addressed most of the uncertainties that the robot might encounter tends to make robot operations more robust.

A plurality of successful task plans may define a variation envelope for a successful plan type. Accordingly, the task plan selected may be compared with the variation envelope to determine whether to modify 126, store and/or execute 130 the task plan 130. When the desired task plan is identified, then the task plan can be executed 130 by the robotic device. The task plans can be executed by one or more robots compatible with the task plans and this may include stationary or mobile robots of many different types.

In another embodiment, where parts are being acquired, manipulated, and/or deposited by a robot, the objects themselves can provide their own information via robot-readable information (i.e., invisible to humans), in order to provide: object identification, object orientation information, preferred manipulator gripping location, and/or other instructions useful in completing a desired task plan.

The sensors of the robotic devices may identify non-visible markings 128 on objects using a robotic device sensor. The non-visible markings may be compared to operations associated with recorded non-visible markings stored in a learning data store of successful task plans in order to determine whether a task plan is executing correctly.

In a slightly different scenario, the system may identify non-visible markings 128 on objects using a robotic device sensor. Then the non-visible markings may be compared with stored non-visible markings to identify operations, poses, discrepancies, differences or additional instructions that may be used in order to modify a command for carrying out the task plan. This allows objects to be covertly marked to help the actions of the robots to be more robust. People cannot perceive a marking outside of human vision and the outside layer of an object may be marked in a non-visible ink (e.g., infrared). The non-visible marking can transmit a variety of identification information and orientation information to the robot. For example, the robot may know if the robot detects a defined symbol on an object then the object is upside down. The non-visible markings may include a collection of instructions or show a location for picking up the part.

In one embodiment, a data store of successful task plans can include non-visible markings in the successful task plans to be used for comparing and modifying all or part of the task plans by comparing the non-visible markings in the successful task plans of a success based learning data store to the task plans being generated. These non-visual markings can be considered a part of the success-based learning database to help correct or improve operations or given commands for carrying out a task. So, the non-visual markings or indicia can represent a ground truth that can used to improve outcomes.

The non-visible markings are a limited data set for comparing with the task plans being generated. For example, if the task is to pick up a part, but the part is in the wrong orientation or position, then the indicia can be read to correct the problem. The non-visible markers can provide information that can be used to understand whether the task that is about to be executed is consistent with what should be occurring or whether this task action is the most successful way to perform the desired task plan, for example. In this way information from the non-visible indicia can be a sub-set of success based learning data.

The non-visible markings or indicia can also be used as a separate check that is unrelated to the successful task plans. The non-visible markings can be used to independently compare with the task plans. Thus, as a task plan is executed, on-part documentation or indicia can be read by sensors of the robot system. The data can be read from the non-visible markings and the robot can determine what additional action to take from there. For example, the robot may use a sensor or camera (e.g., infrared, ultraviolet, or x-ray) determine that the task plan is being performed wrong or confirm that the task plan is actually correct. The sensor or camera on the robotic system can read the non-visible indicia on objects or the workplace. For instance, the robot's previous analysis may have determined there are three possible grab positions on an object but sensor detection may determine that the robot only has one actual grab position on the object that is shown by the non-visible markings. In further example, the machine vision can read non-visible information from the parts that are encoded with such data. However, it may only be possible to see certain markings if the object is in a specific position or orientation. This may allow the robot to see where the robot needs to grab, where the robot should go, identify a part, identify an orientation, identify where to grip, etc., based on in part on the pose of the object and the non-visible markings that are currently being detected.

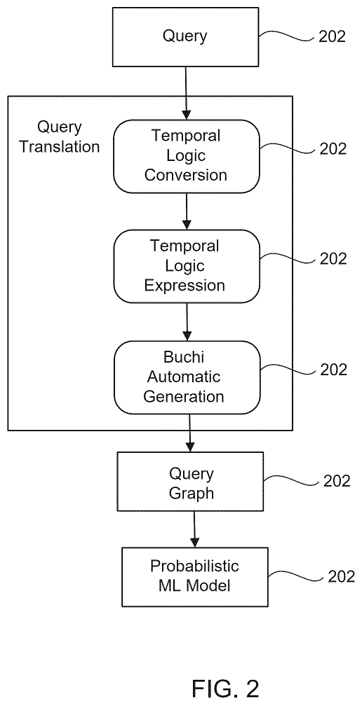

FIG. 2 is a block diagram illustrating an example of a query (e.g., language instructions) translation process that creates query graphs and probabilistic machine learning models. The queries may span the state and observation space of probabilistic machine learning models. The queries may be evaluated by performing inference over probabilistic machine learning models conditioned on the queries. The types of queries allowed can constrain the structure of the probabilistic machine learning models and focus the choice of observations.

The query translation process can transform FOL (first order logic) queries or predicates into query graphs that guide inference over the probabilistic machine learning models to produce answers to queries (e.g., human requests). For example, a question expressed in formal language can be converted into Linear Temporal Logic Expression (LTLE) that specifies relations between several states in time. The LTLE can be used to create a probabilistic machine learning model by generating a Buchi Automaton. The query graph can guide and constrain inference over the probabilistic machine learning model and can result in a tractable inference.

Sample LTL (Linear Temporal Logic) syntactic elements may illustrate the expressivity available. LTL Syntax (with base propositions P) may be built from:
Atomic propositions: P={p1, . . . , pk}
   pᵢ: S→{true, false} is a predicate on states
   pᵢ: S→{a, b, c} with variables over naturals defines state space that includes: <a=0,b=0,c=0>, <a=1,b=0,c=0>, <a=1,b=1,c=0>, <a=932,b=5609,c=6658>, . . .
Boolean connectives: {¬, ∨, ∧, →)—i.e., (not, or, and, implication)
Temporal operators: (□, ⋄, U, O)
   If (ϕ and φ are predicates, then
□ ϕ, “always”, “forever”
⋄ ϕ, “eventually”, “sometimes”
O ϕ, “next time”
ϕ U<φ “until”
Combinations of temporal modal operators can capture more complex query syntax
□ ⋄ ϕ, . . . “ϕ, will happen infinitely often”
⋄ □ ϕ, . . . “ϕ, will happen from some point forever”

An inference in the probabilistic machine learning models conditioned on Temporal Logic and Buchi Automaton queries can answer the questions or tasks posed by a user. The goal may be to determine whether probabilistic machine learning models satisfy the queries received. As discussed, the sensor probabilistic machine learning model can characterize behavior of objects, activities and relationships in a scene of interest.

The queries or questions can be encoded using Temporal Logic Formalism and may be mapped to the sensor probabilistic machine learning model or compatible automaton (Query-LT Formula, ϕ). The LTL expression can be translated into an automaton or sequence of automaton states in event space—A_{ϕ}(r₁), r₁=s₀ s₁ s₂ s₂ s₃ s₃ s₃ . . . The queries may constrain the structure of the probabilistic machine learning model and focus the choice of observations.

Bayesian Inference can be used to determine whether probabilistic machine learning models satisfy the queries with at least probability h, (i.e., G, S₀|=P_{≥h}(ϕ), h(<t>) (where “|=” is read “satisfies”)). The Buchi Automaton can provide “trajectories” that are sequences of states over event space—over which inference occurs to construct event probabilities within probabilistic machine learning models.

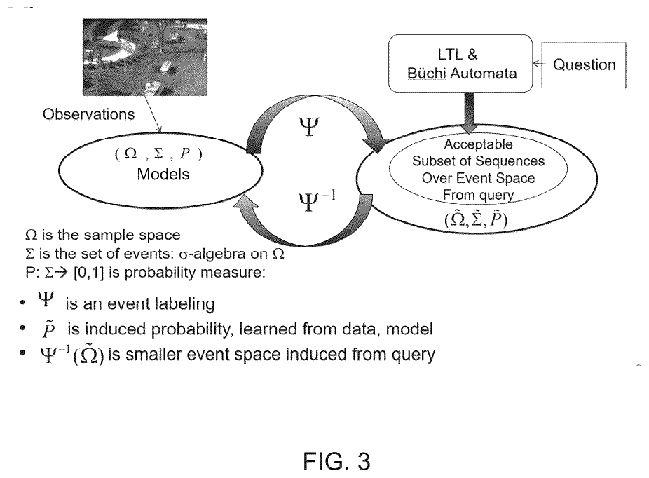

FIG. 3 is a diagram illustrating an example of how an inference can be conditioned on a query model or task probabilistic machine learning model that interacts with a sensor probabilistic machine learning model.

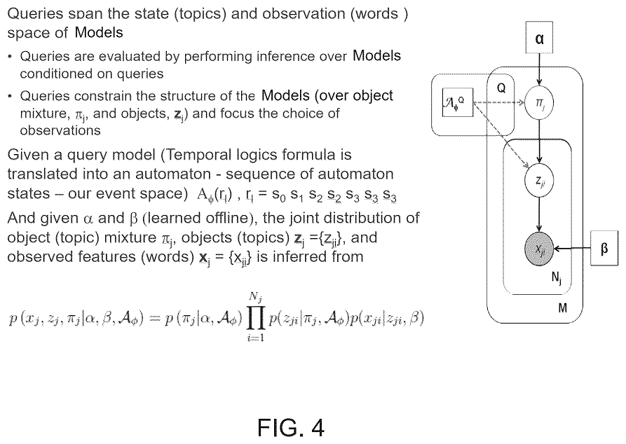

FIG. 4 is a diagram illustrating an example of an inference that can be based on a query (language instruction) model. FIG. 4 illustrates a task probabilistic machine learning model or state diagram (e.g., a state table) created from the user's instructions.

A method may also be provided for generating a task plan that is usable by a robotic device in a workspace. The method may include receiving instructions to perform a task using the robotic device. A plurality of motion primitives may be identified or retrieved from a data store of recorded task plans. For example, the recorded task plans may be successful task plans stored in a success based learning data store, as described earlier. The motion primitives may be basic motions that can be performed using the robot, for which the instructions have been received.

The motion primitives that can be used for a task plan can be selected using a hierarchical probabilistic learning model. The motion primitives can be combined together to form a task plan to be further modified or executed using the robotic device. These motion primitives may be stitched together to find a combination of motion primitives that can perform the desired task. Having the known motion primitives and the task from the instructions, then allows the process to find a desirable combination of primitives to solve the particular robot task. When enough motion primitives are combined, then the robot may have a long horizon task to be performed.

In one example the hierarchical probabilistic learning model can be a hierarchical Bayesian Program Learning (HBPL) model or another model that can hierarchically select motion primitives using probabilities to determine the primitives that should be included in the task plan.

The combination of HBPL as applied to robotics allows the robots to perform the instructions received by creating task plans for the robots. For example, a motion primitive may be to: move from point A to point B, then move in a circular trajectory (or arcs that are primitives). Combining a number of arcs may allow the robot to create and execute a wide variety of trajectories (in addition to a circle of course).

In addition, a human demonstration can be given about how the task plan should look. The generated tasks can be matched to the human performed optimization. The task execution also can be optimized based on the basic primitives that have been selected. The task or query is received by spoken language, text, etc. and the motion primitives are stitched together for the task plan.

The process can compare the generated task plan to other tasks that already exist that are similar or are known to be useful to determine a probability that the task plan will perform the task. There may be different configurations or variations for executing the task plan. The task plan parameters may be for a task that is feasible or for a task that is optimal in some way (e.g., time, power, speed, part assembly quality, etc.).

One useful result of this technology is that the technology avoids the robot configurations where the robots must keep repeating the same tasks deterministically, as is generally the case with currently pre-programmed robots. In the past, when a robot owner wanted to change the robot tasks, then the robot was shut down for a relatively long period of time (e.g., many days or even weeks). Shutting down robots for software or control changes is costly and a loss of the robot as a resource during such a period is also inconvenient. This process has the ability to create a new task based on the motion primitives selected using HBPL (Hierarchal Bayesian Program Learning) that satisfies the task goal. In addition, new tasks can be created for the robot using instructions received that were provided by users of the robot.

In one example, HBPL can be used to select the tasks and stitch the tasks together. The task plans in a success based learning data store can be used as a template for the best way to stitch or combine the motion primitives together. The task plans in the success based learning data store can be broken down into primitives that are, for example: a straight line, an arc, a curve, a lifting motion, etc. When a user instructs a robot to put an object in a location, the actions for the new task plan may be decomposed into: 1) approaching the object, 2) moving in a big arc, 3) avoiding an obstacle and 4) placing the object. These higher level actions are composed of smaller sized motion primitives. When the primitive motions are sampled or selected, this generates different trajectories for doing the same task (even while the task is still executing).

The task plans created and stored for success based learning (as described earlier) can be used to create or identify motion primitives. This may result in a library of primitives. When the motion primitives are combined with the sampling technique, this may result in the generation of a complete task for the robotic system. This process for creating the tasks is not deterministic and each time a task plan may vary depending on the situation or environment state detected by a robot. The current process allows for the creation of complex tasks through the use of hierarchical organization.

Combining the motion primitives together can provide different dynamic motion from the robots that cannot generally be anticipated with human experience. Sometimes, the robot provides motions that may not have seemed possible given the robot's abilities. This means the robot may do something unexpected but effective to get the task done.

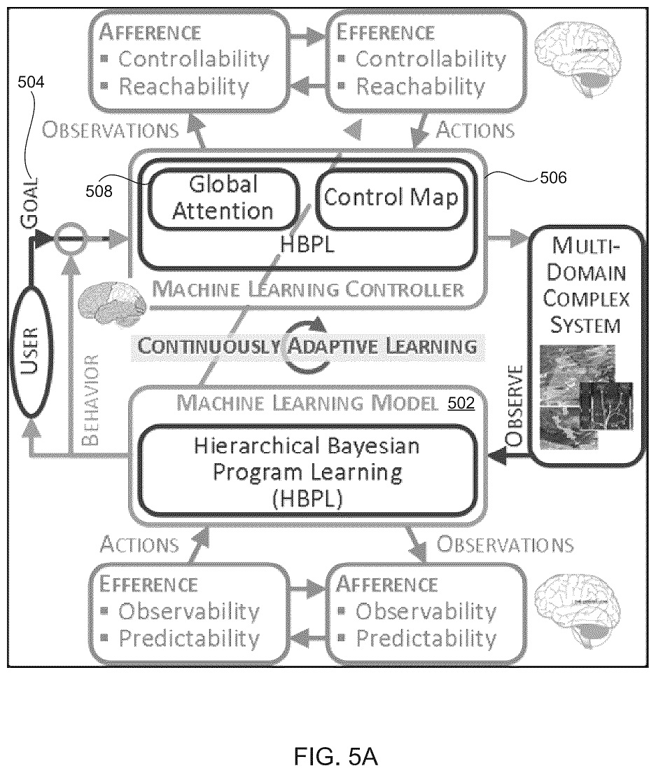

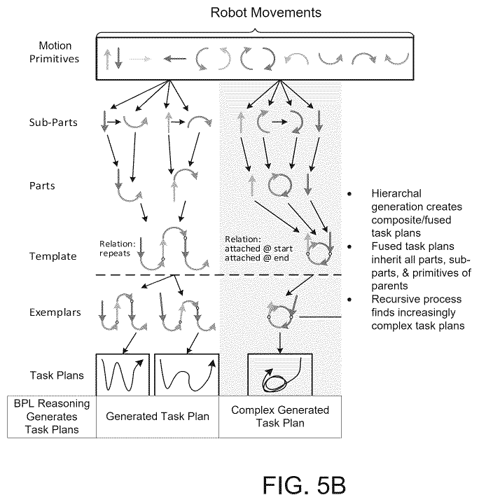

FIG. 5A illustrates a task plan generation architecture using machine learning behavior and performance guarantees while continuously learning and adapting to changes in a physical environment. The architecture has robust machine learning algorithms to learn and infer using multi-domain sparse and uncertain data across the multiple dimensions of time, space, domains, and actions. These machine learning models enable the system to improve its performance over repeated engagements, identify and adapt to adverse events, and decrease the recovery time from specific adverse events.

The machine learning approach can include and unify (1) stochastic adaptive game control theory for hybrid dynamic systems, (2) dynamic hierarchical Bayesian Program Learning and (3) reinforcement learning to enable artificial systems to learn continually about their environment as they operate, and (4) application of previous knowledge to new situations to adaptively create optimal plans and courses of action to increase the speed and scale of operations without increasing self-complexity.

The framework can integrate major elements as in FIG. 5A. The machine learning model block 502 may leverage Bayesian Program Learning (BPL), with non-parametric statistical estimation, deep generative Bayesian models, and machine learning. The extensions to BPL efficiently discover recurring patterns of multi-domain varying behaviors at multiple levels of abstraction. Addition of this multi-level functionality produces a hierarchical form of BPL, known here as HBPL (Hierarchal Bayesian Program Learning). HBPL can learn multi-domain, time-space-frequency-varying courses of action.

HBPL captures human-like learning abilities that have the ability to generalize and learn new concepts from a few examples or in the presence of noisy/incomplete examples. Learned models represent concepts as programs that best explain observed examples under a Bayesian criterion. HBPL makes a few assumptions about underlying dynamics. Further, HBPL learns to autonomously and/or based on user-provided goals 504 (FIG. 5A, User/Goals) to synthesize and discover plans and courses of actions across domains (e.g., to defeat an intelligent adversary, and/or execute manipulation tasks while dynamically avoiding changing constraints). For example, this extended HBPL can recognize and learn to generalize a new concept (cyber-attack) after a limited number of noisy/incomplete examples of cyber-attacks. The HBPL algorithm can learn richer representations than traditional machine learning approaches do, using them for a wider range of functions, including creating new exemplars, parsing threats into parts and relations, and creating new abstract categories of threats based on existing categories. In contrast, many of the leading extant approaches in machine learning are also the most data-hungry, especially “deep learning” models that have achieved new levels of performance on object and speech recognition benchmarks. This data greed, along with iterative batch learning or training (as opposed to incremental online learning), make such approaches unsuitable for applications that HBPL can address.

HBPL may constructively learn programs that combine primitives into sub-parts, parts, and objects, allowing them to create new exemplars (e.g., variations of plans given learned distributions), and creating new abstract plans based on existing ones. Additionally, an extension to a Hierarchical BPL (HBPL) framework can learn shared structure within cooperating multi-agent teams of decision makers allocated to a specific multi-domain problem. This supports multi-objective planning capabilities planning with attrition, degraded communication, and planning in the presence of an active adversary. This approach breaks multi-objective planning into subsets, learning to understand shared structure. HBPL addresses a central challenge of ML: What representation types can be learned from only a few examples, and can they support flexible generalization?

FIG. 5B is a chart illustrating an example of a task plan generation capability that learns compact models to generate operations or behavior patterns with limited training data. HBPL may provide rich, compositional task plan generation capability for modeling complex, subtle features and behavior models. Motion primitives can be used as sub-parts and combined together into parts. Parts may be joined together using templates into exemplars or examples and then finally into task plans. Complex task plans may also be created using HBPL.

This framework includes at least three aspects—compositionality, causality, and learning to learn. Planning programs are built “compositionally” from simpler planning primitives (e.g., detailed tasks for local resources, and placeholder options for supporting tasks from other multi-agents represented as stochastic “motor” programs, where “motors” represent planners' plan fragments as generating elements). Planning programs' probabilistic semantics can handle noise and support generalizations in a procedural form that naturally captures the abstract “causal” structure of plan fragments. A training process constructs programs that best explain the observations under a Bayesian criterion, and the model “learns to learn” by developing hierarchical priors that allow previous experience with related concepts to facilitate learning of new concepts (e.g., new plan fragments classes that can be human-vetted). These priors represent a learned inductive bias that abstracts the key regularities and dimensions of variation across concepts and instances.

The machine learning controller block 506 (depicted in FIG. 5A) may use outputs from the machine learning model 502 (plan generation, recommendation, adaptation, prediction, and synthesis of plans) to create an optimal control policy to search across multi-domain space and “frontend” parameters (i.e., single domain specific characteristics of planning procedures). Over time, this search maximizes effectiveness of applied courses of action while explicitly accounting for actions of an intelligent adversary. Given the parameter space size, a closed form optimization solution is infeasible. Therefore, this technology leverages an “Actor—Critic, Deep Multi-Task, Multi-Domain and Transfer Reinforcement Learning” architecture with adaptable write memory for task-oriented reconfiguration of the planning procedures. This approach incorporates a priori knowledge and instructions using end-to-end training in two modules in the machine learning controller 506: Global Attention (GA) and Control Map (CM), which uses a Deep Reinforcement Learning Controller—CM-DRLC). Encompassing these modules, a version of HBPL oversees generation/discovery of new instances of courses of action. Due to the large control space, memory management is essential to keep policy search manageable.

The global attention (GA) module 508 gates feature maps (i.e., plan primitives) based on the attention vector corresponding to each plan primitive from the machine learning model (FIG. 5A). The GA output helps predict the optimal action to take at a given domain space and time step. In comparison to conventional deep learning neural networks and sequential optimization algorithms that become intractable, the practical benefit of this approach is that this selection mechanism propagates only important signals to the policy learner. A plethora of evidence points to similar global attentional processes in visual cortex.

The machine learning controller may also be a high level reasoner. In order to do planning and deal with uncertainties. For example, if a part that is needed is not there the machine learning controller may decide what to do. If a part cannot be identified, then the robot may jog the part, so the robot can put the part into a configuration that can identified.

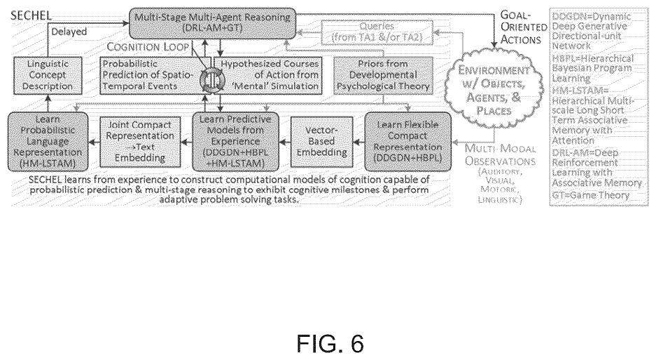

FIG. 6 illustrates a cognitive compositional learning architecture with a single unified learning approach to address challenges. The architecture learns from experience to construct computational models of cognition capable of probabilistic prediction and multi-stage reasoning to exhibit cognitive milestones and perform adaptive problem solving tasks using the functional components described next.

One component is the Learn Flexible Compact Representations. This component may be a combination of multimodal multiscale Dynamic Deep Generative Directional-unit Networks (DDGDNs) with structured hierarchical Bayesian Program Learning (HBPL) which learns (unsupervised and/or semi-supervised) flexible compact concept representations at feature, category, and behavior levels from streaming data. DDGDN+HBPL supports (1) fusing multiple sensing modalities (vision, auditory, motor, linguistic) of the same phenomena to leverage inter-modal dependencies and phenomenology, and (2) transfer, low-shot, and generalization learning to create new classes for concept variants.

Another component is the Learn Predictive Models from Experience. This component may include a Hierarchical Multi-scale Long Short Term Associative Memory (HM-LSTAM) network with an Attention Mechanism which reliably learns to predict expected and unexpected events (containing objects and agents) and evolving activities (places) from experience using a grounded representation inferred by DDGDN-HBPL. DDGDN, HBPL, and HM-LSTAM are generative end-to-end learning models with adaptable memory (flexible associative storage and retrieval, high capacity, and parallel memory access) that project features to future time steps, decoding to input space, and prediction of spatial-temporal events.

A further component is the Learn Probabilistic Language Representation. The HM-LSTAM network also learns a language representation of the observed and learned objects, places, situations, to automatically generate narratives describing these situations and scenes and to adapt to new situations. This module captures and expresses relationships between detected, recognized, and tracked objects, agents, places in natural language to bridge the gap between semantic and data driven reasoning (e.g., learn object labels from language).

Yet another component is the Multi-Stage Multi-Agent Reasoning. This component may use Deep Reinforcement Learning with adaptable memory (DRL-AM) reasons over predicted, inferred objects, activities, concepts to provide spatial-temporal navigation (places) over scenes with various interacting objects (intuitive physics) and intentional actions of agents inferred using game theoretic cooperative and non-cooperative multi-agent sequential (iterative) optimization. This module adaptively learns correct responses in varied situations to demonstrate cognitive capability such as multi-stage reasoning.

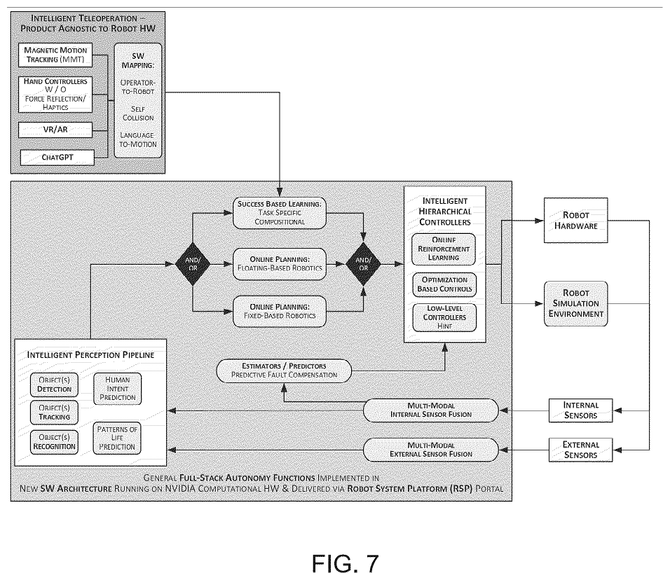

FIG. 7 illustrates a general closed-loop autonomy architecture to deliver value added software services. The framework for achieving generalizable closed-loop autonomy in unstructured environments, as in FIG. 7, begins with the observations from various internal robot sensors, including encoders, force moment sensors, inertial measurement units, and more. These sensors provide a wealth of multimodal data. This data may be processed using a multi-sensor internal sensor fusion estimation system, enabling estimation of physical variables that are not directly observable, such as joint velocities and accelerations.

One of the attributes of this module is the ability to handle sensor noise and failures, providing redundancy to ensure robust performance. Additionally, the module can incorporate sensorless hybrid estimation and prediction of contact forces and moments between the robot and its environment. This not only enhances the overall control and stability of the robot but also reduces the overall system cost by eliminating the need for expensive and often customized sensors to measure forces and moments.

Simultaneously, a variety of multimodal sensors, including depth cameras, LiDAR, and radar, can be used to observe both the robot's workspace and the surrounding environment. The multimodal fusion module may process raw and feature-based sensory data to create a unified abstract representation. This representation can serve as a foundation for robust object detection, tracking, and identification. Importantly, the system can maintain continuous object detection, tracking, and identification even when one or more sensing modalities are compromised (e.g., due to smoke obstructing cameras, while LiDAR or radar remain effective).

Object detection can be executed through machine learning algorithms, which require minimal training data. Tracking may be performed using probabilistic multi-object tracking algorithms specifically designed to handle dynamic scenes. These algorithms are computationally efficient, making them suitable for deployment on edge computational hardware constrained by size, weight, and power (SWAP).

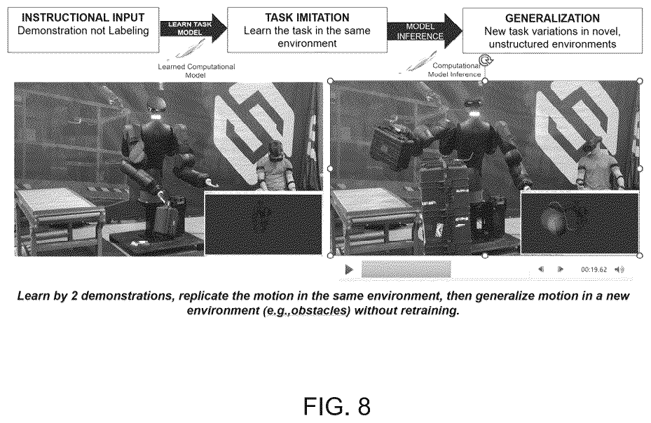

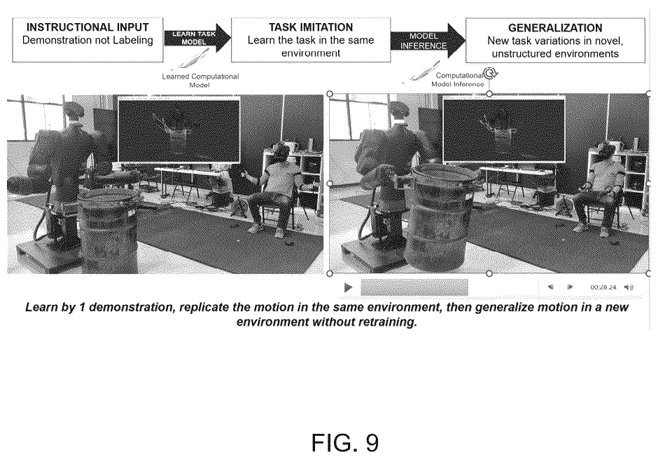

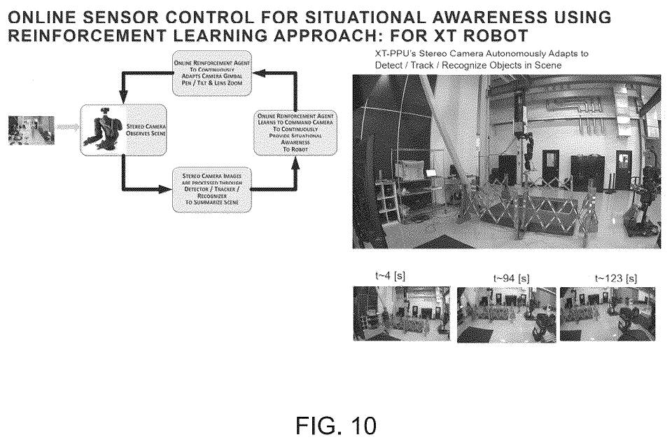

The intelligent perception module may be responsible for achieving accurate situational awareness (SA) by integrating data from both interoceptive and exteroceptive sensors. This integration is facilitated through Multi-Modal Sensor Fusion, employing advanced Reinforcement Learning algorithms. These onboard edge processing algorithms extract features, detect and semantically classify objects, and analyze dynamic relationships among these features and objects. These approaches empower both robotic platforms and human operators to collaboratively develop a 3D model of the robot's environment over time, all while optimizing available communication bandwidth. Visual attention algorithms generate a variable-detail model of the robot's surroundings, emphasizing higher fidelity in more ‘important’ areas compared to less salient regions. Information prioritization for communication to the operator is determined by a combination of bottom-up cues (e.g., salient objects) and top-down cues (e.g., objects marked as significant by stored semantic SA models or the operator's interest). FIGS. 8 and 9 illustrate examples of online sensor control for robot situational awareness

Closed-loop interactions between the platform and operator continuously refine the attention-based, resolution-adaptive 3D model. The platform may promptly inform the operator of newly detected objects, obstacles, or potential threats. These elements of interest receive dedicated processing resources to create high-fidelity representations, while the remainder of the scene relies on extrapolation from previous views or low-fidelity updates. Operator feedback can guide world model construction and the selection of sensory goals/actions from a library of visual routines (e.g., ‘look here,’ ‘touch this’). Additionally, the operator can correct erroneous aspects of the developing 3D model, such as marking areas as ‘traversable.’ This operator feedback aids the robot in planning movements and deciding where to focus next to provide the next round of information, thus closing the loop. The foundation of this approach lies in perception primitives, including 3D mapping, map traversal planning, context awareness, attention, object recognition, and tracking. These primitives, driven by ML/AI algorithms, collect information about 3D scene shape, scene context, objects, salient features, and high-value targets. This information is combined to form an augmented 3D model of the robot's surroundings, achieved through cooperation between bottom-up processes (e.g., attention, salience) and top-down directives from the operator or platform-internal goals (e.g., ‘remember and track this object,’ ‘look over there,’ ‘move towards this’). The primary focus is on the end effector workspace to autonomously detect and classify objects for manipulation or avoidance.

The intelligent perception module's output may be a dynamically changing list of object poses, each identified by a unique ID, within the robot's workspace. These pose data are subsequently input into the planning and reasoning module, which dynamically generates plans for the robot to manipulate objects, enabling the robot to accomplish various tasks with adaptability and precision.

The online base planner and reasoner operates by taking compact multi-modal representations and poses of objects detected, tracked, and identified within the robot's workspace as inputs. It handles noisy or occluded sensor measurements in real-time, ensuring accurate data processing. This online base planner and reasoner serves as a guiding mechanism for the robot's effector control, facilitating the execution of specific commanded manipulation tasks. By integrating both physics-based and learning-based approaches, the limitations inherent in each when used in isolation can be overcome. This integration results in a more robust and resilient locomotion system, particularly in challenging terrains. As a result, robots equipped with an online planner and reasoner can continually perceive their environment, adapt their actions, and effectively manage complex control problems characterized by competing objectives.

A success-based reinforcement learning (SBRL) process may be a reinforcement learning algorithm that improves upon demonstrated trajectories when these are suboptimal or when solutions to new situations must be found, and a learning system must be able to cope with new situations under one-shot learning requirement. AI powered algorithms empower collaborative robots to learn the compositionality of human activities, i.e., to recognize both activities and their comprising actions; Even a small set of actions and objects can create a large combination of possible activities. AI-powered learning of human activities concurrently (e.g., concurrent learning of actions and recognition of activities) enable generalizable autonomy in which robots (on their own) act as a team member operating under semi-supervised autonomy (man-on-the-loop operation). Training a teleoperated robot through demonstrations gives a certain degree of autonomy (e.g., a Bridge to AI ML-driven Autonomy), which is desirable in the face dynamically changing environments.

The reasoning component of the online-based planner and reasoner, known as the Bayesian Probabilistic Reasoning Engine (BPRE), comprises at least two functional parts. The first functional part autonomously assesses the entire workspace, either independently or with human guidance, to semantically segment it. This segmentation is crucial for understanding and inferring the potential tasks that the robot may need to perform, including the tools to be used. BPRE relies on an abstract representation of manipulation primitives, which the system may derive from the success-based learning module. This allows the system to efficiently acquire complex, multi-part, dynamic behavior signature models for manipulation tasks within the robot's unstructured operating environment.

Subsequently, BPRE employs both the semantic 3D scene interpretation, generated by the intelligent perception module, and the manipulation models to recognize potential manipulation tasks that can be achieved based on the perceived scene. BPRE is versatile, operating in both supervised and unsupervised modes, enabling it to learn models for both known (labeled) and unknown (new) tasks, behaviors, and phenomena.

BPRE's human-like learning capabilities are embedded in a probabilistic framework that utilizes probabilistic generative models expressed as structured procedures. These procedures facilitate the combination of primitives and composites of primitives through an abstract description language. This approach is particularly valuable in addressing the challenges posed by unstructured environmental conditions since it breaks down behavior recognition into manageable subsets, rather than attempting to distinguish among thousands of tasks without an understanding of their shared structure.

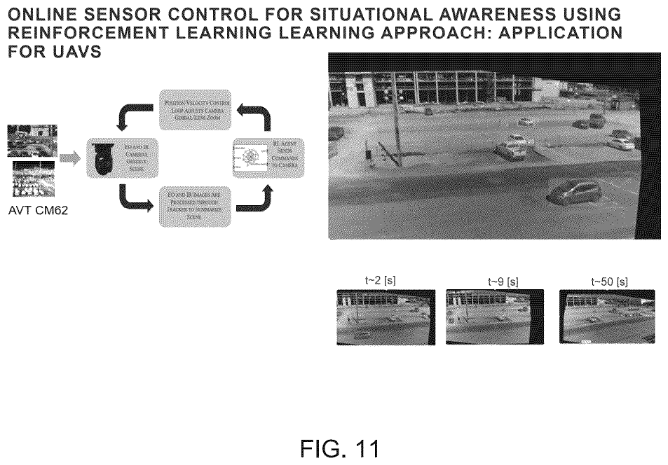

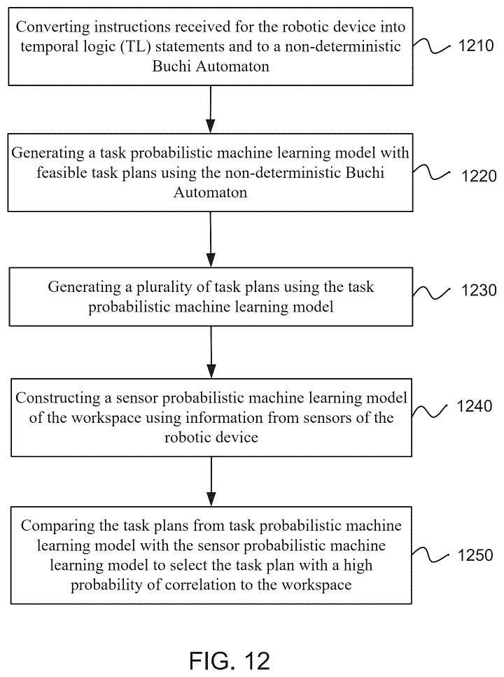

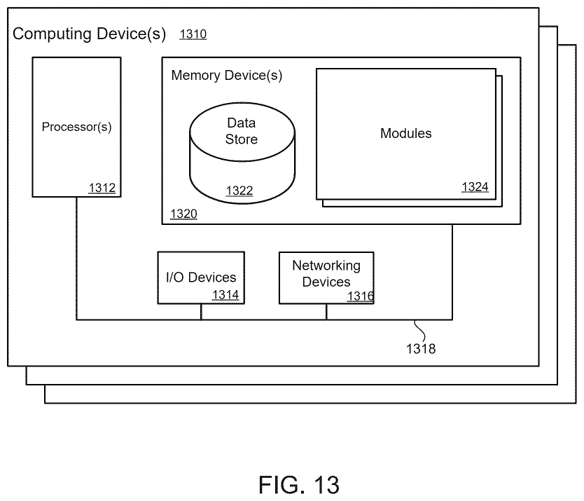

FIGS. 10 and 11 illustrate examples of robots that learn by demonstration and can then generalize tasks in new environments.

### Example Use Cases

This technology may be used in military applications involving mastering complexity while executing Multi-Domain Command and Controls Operations across Air, Space, and Cyber. More specifically, the system creates adaptive machine reasoning and learning systems for decision-making and optimal coordination and planning of distributed multi-agents across Air, Space, and Cyber in the presence of incomplete information and operation in uncertain and contested environments.

Additionally, it is important to note that this AI-based software framework is hardware-agnostic. It can be deployed to enable autonomous operations for a range of robotics systems, including fixed-based robotics such as serial robotic arms, and floating-based robotics such as humanoids, exoskeletons, bipedal robots, quadrupeds, UAVs, and more. These systems are capable of performing dexterous locomotion and manipulation tasks in unstructured environments characterized by constantly changing workspaces and scenes. These environments may include construction, warehouse logistics, situational awareness and surveillance, industrial inspection, and industrial automation.

This technology may be used in autonomous underwater vehicles. The environment for this system is characterized by its unstructured nature, sub-surface conditions, limited visibility, and communication capabilities. The primary tasks the robots are designed for include energy and critical infrastructure monitoring and repair, ship inspection and repair, environmental monitoring and defense applications. Secondary tasks encompass aquaculture, data collection, classification, and mapping.

To ensure the system's success, the robot and its software must possess the ability to perceive and compensate for dynamic environmental changes. It can be trained on dry ground but capable of adapting and performing tasks at sea. The system can be proficient in operating in low-light, unstructured environments and can adapt and generalize tasks without the need for retraining. Additionally, the system can operate safely, ensuring the safety of spacecraft and crew members as environmental conditions change.

A perception pipeline may be used for recognizing and adapting to objects, people, or changes in the workspace. Task generalization and online motion planning enable the system to adjust manipulators and tools to complete tasks as environmental conditions change, while adapting in real-time without requiring retraining. Situational awareness is essential for maneuvering the platform into position, repositioning, identifying hazards to workers, and collaborating with divers in the water. The system may also compensate for shifts in currents, changes in visibility, and unexpected or moving objects due to current shifts. Moreover, the system may possess reasoning and autonomy capabilities. The system can be trained on the ground in multiple tasks, allowing the system to adapt and perform tasks without external input and the latency associated with teleoperation.

Another use case may be space applications. For example, NASA solar panel assembly and deployment. In the challenging space environment, characterized by its unstructured and inhospitable nature with limited communications, the primary task of this technology is to assemble and deploy solar panels. Additionally, the system is designed to handle secondary tasks related to logistics management.

NASA operates in a highly structured environment, relying on specific, well-documented processes for task execution in space. The success of space missions hinges on strict adherence to these processes. For this system to succeed in space, the system must operate in adherence to these meticulous NASA processes. It should be trained on Earth but possess the adaptability to function effectively in space. The system should be capable of perceiving and comprehending its environment and any changes once deployed. The system must also have the ability to adapt and generalize tasks while adhering to processes, all without the need for retraining. Furthermore, the system may be able to compose various task-level libraries to perform complex tasks and handle uniquely different jobs safely.

Safety is paramount, as the system may operate safely even as the space environment changes, ensuring the protection of spacecraft and crew members. The training process involves instructional motion-based training and/or natural language (text to voice) task training on Earth using NASA's documented processes. Success is achieved through learning by demonstrations using teleoperation devices.

Regarding reasoning and autonomy, the system relies on online task generalization and motion planning. It is challenging, if not impractical, to retrain the robot once it has been deployed. Thus, the robot must recognize and adapt to the environment while adhering to defined processes.

An example of the system in operation involves the assembly and deployment of solar panels. Initially, the first panel deployed may be free of obstacles in the workspace. However, as more panels are deployed, potential obstructions may arise, necessitating changes in motion planning while still adhering to the defined process. To facilitate its operations, the system relies on a perception pipeline for identifying unique environmental variables once deployed. This allows the system to operate safely within the workspace without causing damage to spacecraft, ground stations, or equipment.

In a further example, this technology is applicable in manufacturing and assembly line automation and may offer flexibility and adaptability to different tasks. The system is designed for use in structured manufacturing lines with task variability. The primary task the system handles is sub-part assembly, but the system may excel at accommodating changes in the production line, including new products, fixes, and updates. These changes have, in the past, come at a high cost in terms of robot retraining and manufacturing downtime.

To ensure success, the technology is engineered to be cost-effective and capable of rapidly repurposing manipulators and robots for new tasks. It can seamlessly adapt to varying tasks in a multi-product assembly line setup, all while prioritizing safety to protect personnel and prevent damage to robots and products.

The system can employ a multimodal simplified training approach, allowing manufacturers to quickly train a new base model in augmented reality (AR) without the need for deep engineering expertise. As few as two exemplars can suffice for this training. A perception pipeline and sensor fusion may enable the robot to swiftly acquire new parts, components, or sub-assemblies from the base model.

A reasoning engine may play a role in ensuring the manipulator positions itself correctly to complete the new task in the real world. Task and generalization composition capabilities allow the system to combine base task libraries to accomplish a variety of jobs.

As for benefits, this technology minimizes production downtime when retraining for new tasks. Employees can easily train in AR and deploy models across robots with just a simple action, such as pushing a button. It also enables the operation of assembly lines with mixed products, adapting tasks based on the objects detected. Overall, this system provides flexibility and future-proofs the usability and lifespan of robots. For an example of how the system operates, imagine a manufacturing line where the system is deployed. When a new product variant needs to be assembled, an employee uses augmented reality (AR) to quickly train a base model with just two exemplars. The system can adapt to the new task, allowing robots to assemble the new product without extended downtime or complex reprogramming. This adaptability ensures manufacturing lines can efficiently produce a variety of products without costly delays.

A construction example may be structural bolt tightening. This technology is applicable for construction applications, specifically focusing on structural bolt tightening in unstructured environments. These environments can vary from ground-level to at-height locations, both indoors and outdoors, often incorporating the use of heavy tools. The primary task the system excels at is the identification and precise torquing of bolts on large steel structures, including bridges, large buildings, and manufacturing facilities. Additionally, it can handle secondary tasks such as inspecting and repairing damaged bolts and moving, aligning, and securing steel beams as part of the construction process, often referred to as ‘cooning.’ The level of precision and speed required for these tasks is beyond what traditional teleoperation or training models can achieve, particularly when working at heights. There are also significant risks associated with at-height work, especially in inclement weather conditions. For this technology to succeed, it may meet several requirements. These include the precision detection of bolts and the precise placement of tools, adaptability to varying environmental conditions at different heights, and the ability to operate safely as the environment changes to ensure the safety of personnel.

To accomplish these tasks, the system may employ a perception pipeline that identifies the workspace and bolts. The system may utilize online motion planning to position torque guns precisely on the bolts. Task generalization enables the system to adapt and torque bolts in various situations, including different angles, overhead positions, or when working from above. This adaptability is unique to each beam location and different construction sites. Task composition capabilities allow the invention to place bolts first and then apply torque as needed. Situational awareness ensures the system can maneuver platforms into position, reposition as required, and identify potential hazards to workers.

Moreover, the system possesses reasoning and autonomy features. It is trained on the ground in multiple tasks, enabling the system to perform individual tasks or compose more complex sets of tasks at height without the need for extensive retraining. As an example of how the system operates, imagine a large construction site where steel beams need to be precisely secured in place. The system, equipped with its perception capabilities, identifies the bolts and uses online motion planning to position the torque gun with precision. The system then torques the bolts to the defined specifications, all while adapting to the specific conditions at different heights. This level of automation not only ensures accuracy but also enhances safety and efficiency in complex construction tasks.

Another use case may be de-icing of an airplane at a gate. Precipitation measurement employs a compact 1-inch cube, influencing key aspects of de-icing, such as the extent of spray coverage (whether via multiple passes or a single sweep) and the precise orientation of the spraying nozzle. An ideal de-icing robotic solution may exhibit adaptability to shifting weather conditions. Furthermore, controlling the orientation of the robot's end-effector is critical to ensure an optimal flow pattern and coverage area.

Incorporating knowledge of the airplane's surface is paramount. It enables the system to maintain the end-effector's orientation perpendicular to the surface, thus optimizing the robot's dexterity and manipulability within its workspace. Should the robot approach the edges of this workspace or encounter a low manipulability index, this serves as a triggering event for repositioning the vehicle boom into a new configuration, facilitating continued surface coverage. Additionally, once the maximum feasible coverage is achieved from a single waypoint where the robot-equipped vehicle is stationed, a command is issued for the vehicle to transition to a new waypoint. This strategic relocation ensures the seamless continuation of the de-icing process.

FIG. 12 is a flowchart illustrating a method for determining a task plan that is usable by a robotic device in a workspace. The method may include converting instructions received for the robotic device into temporal logic (TL) statements and to a non-deterministic Buchi Automaton, as in block 1210. The instructions may be received using at least one of: a verbal query, a text query, or a graphical query. The sequence of actions may be received through instructions in a domain-specific language.

A task probabilistic machine learning model with feasible task plans may be generated using the non-deterministic Buchi Automaton, as in block 1220. The non-deterministic Buchi Automaton may include states and a transition function to modify states based on actions and predicates.

A plurality of task plans may be generated using the task probabilistic machine learning model, as in block 1230.

A sensor probabilistic machine learning model of the workspace can be constructed using information from sensors of the robotic device, as in block 1240. The sensor probabilistic machine learning model may classify objects and estimates poses of objects in the workspace. The sensor probabilistic machine learning model can classify objects that need to be manipulated by the robotic device and objects that need to be avoided by the robotic device during task completion.

The task plans from task probabilistic machine learning model can be compared with the sensor probabilistic machine learning model to select the task plan with a high probability of correlation to the workspace, as in block 1250. The comparing of the plurality of task plans from the task probabilistic machine learning model with the sensor probabilistic machine learning model may be performed using Bayesian inference with a defined probability threshold.

The task plan can also be executed by the robotic device. In some situations, a pose of an object that is not identifiable using a robotic device sensor can be modified in order to allow the object to be recognized.

The task plan may be modified to correct for deficiencies as compared to stored successful task plans, workspace data, or non-visible markings on objects. A learning data store can be created to store successful task plans completed by a human. The task plan selected can be compared to stored successful task plans to determine whether to execute the task plan. A successful task plan is defined as successful based in part on completion by a user using the robotic device. In one example, a plurality of successful task plans may define a variation envelope for a successful plan type. The task plan selected can be compared with the variation envelope to determine whether to execute the task plan.

FIG. 13 illustrates a computing device 1310 on which modules of this technology may execute. The computing device 1310 is illustrated on which a high level example of the technology may be executed. The computing device 1310 may include one or more processors 1312 that are in communication with memory devices 1320. The computing device may include a local communication interface 1318 for the components in the computing device. For example, the local communication interface may be a local data bus and/or any related address or control busses as may be desired.

The memory device 1320 may contain modules 1324 that are executable by the processor(s) 1312 and data for the modules 1324. The modules 1324 may execute the functions described earlier. A data store 1322 may also be located in the memory device 1320 for storing data related to the modules 1324 and other applications along with an operating system that is executable by the processor(s) 1312.

Other applications may also be stored in the memory device 1320 and may be executable by the processor(s) 1312. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 1316 and similar communication devices may be included in the computing device. The networking devices 1316 may be wired or wireless networking devices that connect to the internet, a LAN, WAN, or other computing network.

The components or modules that are shown as being stored in the memory device 1320 may be executed by the processor 1312. The term “executable” may mean a program file that is in a form that may be executed by a processor 1312. For example, a program in a higher level language may be compiled into machine code in a format that may be loaded into a random access portion of the memory device 1320 and executed by the processor 1312, or source code may be loaded by another executable program and interpreted to generate instructions in a random access portion of the memory to be executed by a processor. The executable program may be stored in any portion or component of the memory device 1320. For example, the memory device 1320 may be random access memory (RAM), read only memory (ROM), flash memory, a solid state drive, memory card, a hard drive, optical disk, floppy disk, magnetic tape, or any other memory components.

The processor 1312 may represent multiple processors and the memory 1320 may represent multiple memory units that operate in parallel to the processing circuits. This may provide parallel processing channels for the processes and data in the system. The local interface 1318 may be used as a network to facilitate communication between any of the multiple processors and multiple memories. The local interface 1318 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for determining a task plan that is usable by a robotic device in a workspace, comprising:
converting instructions received for the robotic device into temporal logic (TL) statements and to a non-deterministic Buchi Automaton;
generating a task probabilistic machine learning model with feasible task plans using the non-deterministic Buchi Automaton;
generating a plurality of task plans using the task probabilistic machine learning model;
constructing a sensor probabilistic machine learning model of the workspace using information from sensors of the robotic device; and
comparing the task plans from task probabilistic machine learning model with the sensor probabilistic machine learning model to select the task plan with a high probability of correlation to the workspace.

2. The method as in claim 1, wherein comparing the plurality of task plans from the task probabilistic machine learning model with the sensor probabilistic machine learning model is performed using Bayesian inference with a defined probability threshold.

3. The method as in claim 1, further comprising:
modifying the task plan to correct for deficiencies as compared to stored successful task plans, workspace data, or non-visible markings on objects.

4. The method as in claim 1, further comprising:
creating a learning data store with successful task plans completed by a human; and
comparing the task plan selected to stored successful task plans to determine whether to execute the task plan.

5. The method as in claim 4, wherein a successful task plan is defined as successful based in part on completion by a user using the robotic device.

6. The method as in claim 4, wherein a plurality of successful task plans may define a variation envelope for a successful plan type.

7. The method as in claim 6, further comprising comparing the task plan selected with the variation envelope to determine whether to execute the task plan.

8. The method as in claim 1, further comprising receiving a sequence of actions through instructions in a domain-specific language.

9. The method as in claim 1, wherein the instructions are received using at least one of: a verbal query, a text query, or a graphical query.

10. The method as in claim 1, wherein the temporal logic (TL) statements comprise states, actions, and predicates.

11. The method as in claim 1, wherein the non-deterministic Buchi Automaton includes states and a transition function to modify states based on actions and predicates.

12. The method as in claim 1, wherein the sensor probabilistic machine learning model classifies objects and estimates poses of objects in the workspace.

13. The method as in claim 12, wherein the sensor probabilistic machine learning model can classify objects that need to be manipulated by the robotic device and objects that need to be avoided by the robotic device during task completion.

14. The method as in claim 1, wherein the task plan is executed by the robotic device.

15. The method as in claim 1, further comprising modifying a pose of an object that is not identifiable using a robotic device sensor in order to allow the object to be recognized.

16. The method as in claim 1, further comprising:
identifying non-visible markings on objects using a robotic device sensor; and
comparing the non-visible markings to recorded non-visible markings stored in a learning data store of successful task plans in order to determine whether a task plan is executing correctly.

17. The method as in claim 1, further comprising:
identifying non-visible markings on objects using a robotic device sensor; and
comparing the non-visible markings with stored non-visible marking in order to modify a command for carrying out the task plan.

18. A method for determining a task plan that is usable by a robotic device in a workspace, comprising:
converting instructions received for the robotic device into temporal logic (TL) statements and then to a non-deterministic Buchi Automaton;
generating a task probabilistic machine learning model with feasible task plans using the non-deterministic Buchi Automaton;
generating a plurality of task plans using the task probabilistic machine learning model;
constructing a sensor probabilistic machine learning model of the workspace using information from sensors of the robotic device;
creating a learning data store with successful task plans completed by a human using the robotic device;
comparing the task probabilistic machine learning model and the sensor probabilistic machine learning model to select the task plan with a high probability of correlation to the workspace;
comparing the task plan selected to successful task plans or workspace data to determine whether to modify the task plan to improve the task plan; and
executing the task plan using the robotic device.

19. The method as in claim 18, wherein a successful task plan is defined as successful based in part on completion by a user using the robotic device.

20. The method as in claim 18, wherein a plurality of successful task plans may define a variation envelope for a successful plan type.

21. The method as in claim 20, further comprising comparing the task plan selected with the variation envelope to determine whether to execute the task plan.

22. The method as in claim 18, further comprising modifying the task plan to correct for deficiencies as compared to stored successful task plans or workspace data.

23. The method as in claim 18, wherein comparing the task probabilistic machine learning model and the sensor probabilistic machine learning model is performed using Bayesian inference with a defined probability threshold.

24. The method as in claim 18, further comprising receiving a sequence of actions through instructions in a domain-specific language.

25. The method as in claim 18, wherein the instructions are received and a successful task plan is defined as successful based in part on completion by a user using the robotic device.

26. The method as in claim 18, wherein the temporal logic (TL) statements comprise states, actions and predicates.

27. The method as in claim 18, wherein the non-deterministic Buchi Automaton includes states and a transition function to modify states based on actions and predicates.

28. The method as in claim 18, wherein the sensor probabilistic machine learning model classifies objects and estimates poses of objects in the workspace.

29. The method as in claim 28, wherein the sensor probabilistic machine learning model can classify objects that need to be manipulated by a robotic device and objects that need to be avoided by a robotic device during task completion.

30. The method as in claim 18, further comprising:
identifying non-visible markings on objects using a robotic device sensor; and
comparing the non-visible markings to recorded non-visible markings stored in the learning data store of successful task plans in order to determine whether a task plan is executing correctly.

31. The method as in claim 18, further comprising:
identifying non-visible markings on objects using a robotic device sensor; and
comparing the non-visible markings with stored non-visible marking in order to modify a command for carrying out the task plan.

32. A system for determining a task plan that is usable with a workspace of a robotic device, the system comprising:
at least one processor;
at least one memory device including a data store to store a plurality of data and instructions that, when executed, cause the system to:
convert instructions received for the robotic device into temporal logic (TL) statements and to a non-deterministic Buchi Automaton;
generate a task probabilistic machine learning model with feasible task plans using the non-deterministic Buchi Automaton;
generate a plurality of task plans using task probabilistic machine learning model;
construct a sensor probabilistic machine learning model of the workspace using information from sensors; and
compare the task plans from the task probabilistic machine learning model and the sensor probabilistic machine learning model to select the task plan with a high probability of correlation to the workspace.

33. The system as in claim 32, wherein comparing the task probabilistic machine learning model and the sensor probabilistic machine learning model is performed using Bayesian inference with a defined probability threshold.

34. The system as in claim 32, further comprising:
creating a learning data store with successful task plans completed by a human;
comparing the task plan selected to successful task plans to determine whether to use the task plan.

35. A method for generating a task plan that is usable by a robotic device in a workspace, comprising:
receiving instructions to perform a task using the robotic device;
identifying a plurality of motion primitives from a data store of recorded task plans;
selecting motion primitives using a hierarchical probabilistic learning model; and
combining together the motion primitives to form a task plan to be executed using the robotic device.

36. The method as in claim 35 wherein the hierarchical probabilistic learning model is a hierarchical Bayesian Program Learning (HBPL).

37. The method as in claim 35, wherein the recorded task plans are successful task plans stored in a success based learning data store.

38. The method as in claim 35, further comprising:
modifying the task plan to correct for deficiencies as compared to stored successful task plans, workspace data, or non-visible markings on objects.

39. The method as in claim 35, further comprising:
creating a learning data store with successful task plans completed by a human; and
comparing the task plan selected to stored successful task plans to determine whether to execute the task plan.

40. The method as in claim 35, wherein a successful task plan is defined as successful based in part on completion by a user using the robotic device.

41. The method as in claim 35, wherein a plurality of successful task plans may define a variation envelope for a successful plan type.

42. The method as in claim 41, further comprising comparing the task plan selected with the variation envelope to determine whether to execute the task plan.

43. The method as in claim 35, further comprising receiving a sequence of actions through instructions in a domain-specific language.

44. The method as in claim 35, wherein the instructions are received using at least one of: a verbal query, a text query, or a graphical query.
